(19) United States
(12) Patent Application Publication
(10) Pub. No.: US 2025/0161847 A1
(43) Pub. Date: May 22, 2025

(54) Filter for a Fluid Passageway

(71) Applicant: Robert Bosch GmbH, Stuttgart (DE)

(72) Inventor: George Popovici, Woburn, MA (US)

(21) Appl. No.: 18/514,266

(22) Filed: Nov. 20, 2023

(51) Int. Cl. B01D 35/02; B01D 36/04; F28F 19/01

(52) U.S. Cl. CPC B01D 35/02; B01D 36/04; F28F 19/01; B01D 2201/32

(57) ABSTRACT

A fluid delivery system includes a settlement filter that is disposed within a primary fluid passageway and is configured to receive a portion of fluid that passes through the primary fluid passageway. The settlement filter includes a secondary “filter” fluid passageway having an inlet end that intersects the primary fluid passageway and a blind end opposed to the inlet end. At the intersection of filter fluid passageway with the primary fluid passageway, fluid conditions result in formation of a settlement area in the filter fluid passageway entrance. The filter fluid passageway includes a particle trap in the settlement area that collects particles that settle out of the fluid.

### BACKGROUND

Cooling systems used in buildings and vehicles may be a complex aggregation of multiple components which are interconnected via fluid passageways. As used herein, the term “components” refers to devices that contact the fluid passing through the cooling system including pumps, valves, filters, heat exchangers, hoses, pipes, bottles, reservoirs, and any cooling channel in a component through which coolant is routed. A cooling system may operate by passing a fluid (e.g., a coolant) through the fluid passageways between the appropriate components.

During the manufacture of the system components, various manufacturing processes may leave behind deleterious contaminants that subsequently contaminate the coolant. Typical contaminants include sand, metal dust and metal chips. The sand may be a remnant of a casting process or may have been used during manufacturing to abrasively remove component material. The metal dust may be a remnant of a grinding process, and the metal chips may be a remnant of a cutting process. Each of these contaminants are solids, generally abrasive, and of density significantly greater than the fluid coolant of, for example, a typical automotive coolant mixture.

Once introduced into the assembled cooling system, such solid contaminants may be carried along with the flowing coolant and may contact all the components in the cooling system. Such contaminants can negatively affect the components due to abrasive wear and clogging of cooling channels. In some cases, these undesirable effects may lead to premature component failure and decreased system efficiency. It is desirable to remove contaminants from the fluid of a cooling system.

### SUMMARY

Referring to FIGS. 1 and 2, the amount of solid contaminant such as particles or other debris carried by the coolant is a function of the local coolant velocity, the size of the contaminant particle, and the density ratio between the fluid coolant and the solid particle. All other things being equal, a faster moving fluid is more able to keep a given particle in suspension than a slower moving fluid. In addition, when the fluid is at zero velocity, all particles that are more dense than the coolant will fall under force of gravity and settle at the lowest surface of the fluid passageway. As used herein, the term “settle” refers to the effect in which the particles in the fluid gradually sink down under their own weight until they rest on a surface. A filter that is provided in a fluid passageway of an automotive cooling system is configured to take advantage of these settling characteristics of particles suspended in fluid to remove particle contaminants from a fluid coolant. For example, the filter includes one or more secondary passageways that branch off the primary fluid passageway. At the openings to the secondary fluid passageways, turbulence and secondary flows are generated. At the interfaces between the primary and secondary flows, areas of zero or nearly zero fluid velocities occur. These areas of very low or zero fluid velocity within the secondary fluid passageway are referred to as “settlement areas.” The location and size of the settlement areas are dependent on the flow rate of the fluid, the viscosity of the fluid and the difference in density between the fluid and the solid particles.

A settlement filter is provided in a fluid circuit of an automotive cooling system that is configured to take advantage of these fluid flow and particle settling characteristics to remove particle contaminants from a fluid coolant. The settlement filter may include the secondary fluid passageway and a sieve that is provided in a floor of the secondary fluid passageway in the settlement area. As used herein, the term “floor” corresponds to the lowermost portion of the fluid passageway with respect to the direction of gravity of the earth. The sieve includes perforations referred to as “trap openings” that are provided in the floor and are configured to allow passage of particles therethrough under force of gravity. The particles that drop from suspension sink to the floor and may pass through the trap openings. The settlement filter may also include a filter housing that defines a particle trap below the trap openings. The particles become trapped in the particle trap, which prevents the particles from becoming re-entrained in the fluid flow.

In some aspects, a fluid delivery system includes a primary fluid passageway that extends between component of the fluid delivery system. In addition, the fluid delivery system includes a filter. The filter includes a filter housing that defines a first filter fluid passageway that intersects the primary fluid passageway and is configured to receive a first portion of fluid that passes through the primary fluid passageway. The first filter fluid passageway has a first inlet end that intersects and fluidly communicates with the primary fluid passage, and a first blind end disposed at a location that is spaced apart from the first inlet end.

In some embodiments, the first filter fluid passageway has a surface that defines trap openings, and each trap opening is configured to allow passage of particles therethrough under force of gravity.

In some embodiments, the first filter fluid passageway defines a floor corresponding to the lowermost portion of the first filter fluid passageway with respect to the direction of the force of gravity of the earth, and the floor has trap openings configured to allow passage of particles therethrough under force of gravity.

In some embodiments, the filter housing comprises a vacancy that underlies the trap openings. The vacancy is configured to receive and retain particles that pass through the trap openings.

In some embodiments, the first filter fluid passageway has a uniform width from the first inlet end to the first blind end.

In some embodiments, the first filter fluid passageway has a non-uniform width from the first inlet end to the first blind end.

In some embodiments, a width of the first filter fluid passageway increases from the first inlet end to the first blind end.

In some embodiments, the first filter fluid passageway is perpendicular to the primary fluid passageway.

In some embodiments, the first filter fluid passageway is at a non-right angle to the primary fluid passageway.

In some embodiments, the first filter fluid passageway has a first passageway length corresponding to a distance between the first inlet end and the first blind end and a first passageway width corresponding to a dimension of the first filter fluid passageway in a direction perpendicular to the first passageway length and to a direction of the force of gravity, and the first passageway length is at least 1.5 times the first passageway width.

In some embodiments, the filter housing defines a second filter fluid passageway that intersects the primary fluid passageway and is configured to receive a first portion of fluid that passes through the primary fluid passageway. The second filter fluid passageway includes a second inlet end that intersects and fluidly communicates with the primary fluid passageway, and a second blind end disposed at a location spaced apart from the second inlet end.

In some embodiments, the each of the first filter fluid passageway and the second filter fluid passageway has a surface that defines trap openings, and each trap opening is configured to allow passage of particles therethrough under force of gravity.

In some embodiments, the second inlet end is downstream of the first inlet end with respect to a direction of fluid flow through the primary fluid passageway.

In some embodiments, the primary fluid passageway has a primary passageway cross-sectional dimension at a location mid-way between the first inlet end and the second inlet end, and a distance between the first inlet end and the second inlet end is at least 1.5 times the primary passageway cross-sectional dimension.

In some embodiments, the first filter fluid passageway has a uniform width from the first inlet end to the first blind end, and the second filter fluid passageway has a non-uniform width from the second inlet end to the second blind end.

In some embodiments, the width of the second filter fluid passageway increases from the second inlet end to the second blind end.

In some embodiments, the first filter fluid passageway intersects the primary fluid passageway at a first side of the primary fluid passageway, and the second filter fluid passageway intersects the primary fluid passageway at the first side of the primary fluid passageway at a location downstream from the first filter fluid passageway with respect to the direction of fluid flow through the primary fluid passageway.

In some embodiments, the first filter fluid passageway intersects the primary fluid passageway at a first side of the primary fluid passageway, the second filter fluid passageway intersects the primary fluid passageway at a second side of the primary fluid passageway at a location downstream from the first filter fluid passageway with respect to the direction of fluid flow through the primary fluid passageway, and the second side is opposite the first side.

In some embodiments, one of the first filter fluid passageway and the second filter fluid passageway is at a right angle to the primary fluid passageway, and the other of the first filter fluid passageway and the second filter fluid passageway is at a non-right angle to the primary fluid passageway.

The filter is advantageous when compared to some conventional in-line porous-medium filters used to capture contamination. For example, the filter does not create a significant pressure drop since it does not obstruct the fluid path. In addition, the filter does not create an increasing pressure drop as the filter media traps increasing quantities of contamination, as may be the case in the in-line porous medium filters.

### BRIEF DESCRIPTION OF THE DRAWINGS

FIG. 1 is a graph illustrating the relationship between the ability of a fluid to carry particles versus the fluid velocity.

FIG. 2 is a graph illustrating the relationship between the ability of a fluid to carry particles and the ratio of particle density to fluid density.

FIG. 3 is a schematic illustration of a thermal management system that includes a refrigerant subsystem (shown in broken lines) and a coolant subsystem (shown in solid lines), the coolant subsystem including a settlement filter in a primary fluid passageway of the coolant subsystem.

FIG. 4 is a top plan view of the settlement filter with a cover of the settlement filter omitted to permit visualization of the settlement filter.

FIG. 5 is a cross-sectional view of a portion of the settlement filter showing an enlarged top view of a filter fluid passageway. In this view, the direction of fluid flow through the primary fluid passageway is represented by the large solid arrow, and smaller solid arrows represent the flow path of portions of fluid that are received in the filter fluid passage.

FIG. 6 is another cross-sectional view of the settlement filter showing an enlarged side view of a filter fluid passageway.

FIG. 7 is a schematic diagram showing an end cross-sectional view of the primary fluid passageway which extends into and out of the page, and illustrating exemplary orientations of the filter fluid passageways relative to a horizontal plane.

FIG. 8 is a top plan view of an alternative embodiment of the settlement filter with a cover of the settlement filter removed.

FIG. 9 is a top plan view of another alternative embodiment of the settlement filter with a cover of the settlement filter removed.

FIG. 10 is a top plan view of another alternative embodiment of the settlement filter with a cover of the settlement filter removed.

FIG. 11 is a top plan view of another alternative embodiment of the settlement filter with a cover of the settlement filter removed.

FIG. 12 is a top plan view of another alternative embodiment of the settlement filter with a cover of the settlement filter removed.

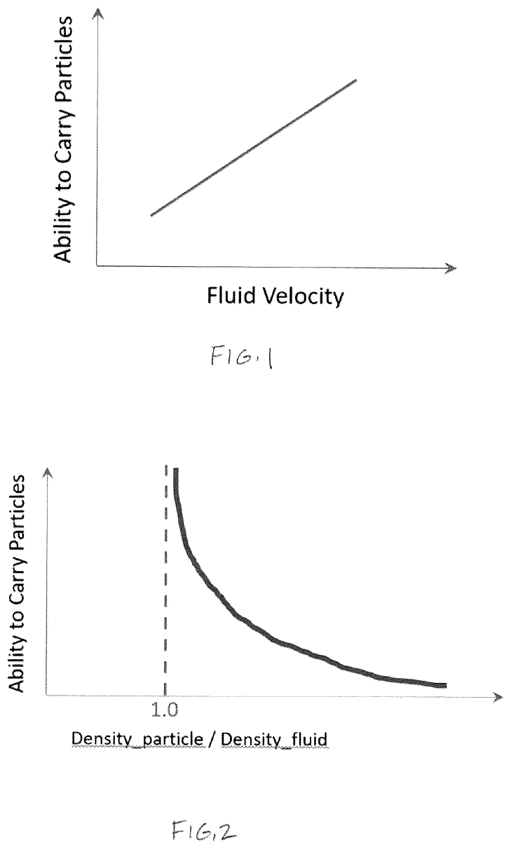

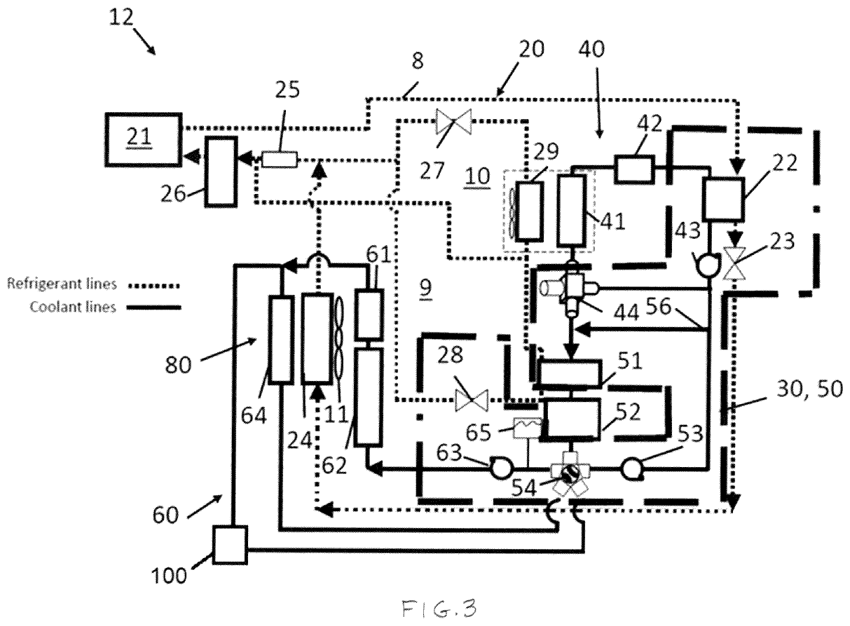

### DETAILED DESCRIPTION

Referring to FIG. 3, a thermal management system 12 for an electric vehicle (not shown) includes a closed-loop refrigerant subsystem 20 and a closed-loop coolant subsystem 30. Each of the refrigerant subsystem 20 and the coolant subsystem 30 include multiple components which are interconnected via primary fluid passageways 1. The primary fluid passageways 1 may be arranged into circuits or loops 8, 9, 10, 40, 50, 60 and may be constituted of piping or hoses. Alternatively, the primary fluid passageways 1 may be channels formed in components or ancillary structures through which fluid is routed. In some embodiments of the thermal management system 12, the primary fluid passageways 1 may be a combination of piping, hoses and/or channels. In the coolant subsystem 30, cooling of the components is achieved by passing the fluid (e.g., coolant) through the primary fluid passageways 1 and the components that are connected by the primary fluid passageways 1. In the coolant subsystem 30, at least one settlement filter 100 is provided in at least one of the primary fluid passageways 1 for removing particles from the coolant. The settlement filter 100 will be described in detail below.

The electric vehicle may be a battery-electric (i.e., all electric) vehicle (BEV), a plug-in hybrid electric vehicle (PHEV), or a hybrid electric vehicle (HEV). As such, the electric vehicle may include at least one electric traction motor for propulsion of the vehicle. For example, the electric traction motor can be mechanically coupled directly or indirectly to rotate one or more wheels of the vehicle. The electric vehicle may in some constructions include a combustion engine. However, in partial- or full-electric driving modes, drive power requirements from the combustion engine are reduced or eliminated. In other constructions, the electric vehicle has no combustion engine operable for propulsion of the vehicle.

To power the electric traction motor, a traction battery is included in the vehicle. The traction battery may be a high voltage battery (e.g., greater than 100 Volts) and may require cooling or heating under certain circumstances. The traction motor, the wheels and the associated controller and power electronics are referred to herein as the vehicle drivetrain. In addition, a cabin of the vehicle that houses vehicle occupants may be provided with climate control for occupant comfort.

The thermal management system 12 includes a closed-loop refrigerant subsystem 20 and the closed-loop coolant subsystem 30. The refrigerant subsystem 20 provides a vapor-compression refrigeration cycle upon a working fluid, or “refrigerant”. The refrigerant subsystem 20 facilitates thermal management of the vehicle drivetrain via a condenser 22 that provides heat transfer to or from ambient space, and also interfaces with the coolant subsystem 30. The coolant subsystem 30 employs one or more proportional valves 44, 54 to selectively combine vehicle drivetrain thermal management via a vehicle drivetrain coolant loop 60, traction battery thermal management via a battery coolant loop 50 and cabin thermal management (e.g., climate control) via a cabin coolant loop 40. Operation of the thermal management system 12 depends upon vehicle operating conditions, ambient conditions, and climate control requirements of the cabin occupant(s). The refrigerant and coolant subsystems 20, 30 of the thermal management system 12 will now be described in detail.

The refrigerant subsystem 20 includes compressor 21. In some embodiments, the compressor 21 may be an electric compressor. The compressor 21 outputs hot refrigerant to a liquid cooled condenser (LCC) 22, which transfers some heat from the refrigerant to the cabin coolant loop 40. The LCC 22 outputs slightly cooled refrigerant to a first expansion valve 23. The first expansion valve 23 may be an electronic expansion valve (EEV) that can selectively be changed between an expansion mode in which fluid passing therethrough is expanded (cooled) and a fully-open mode in which fluid passing therethrough is unchanged. Unless otherwise indicated, the first EEV 23 is operated in the expansion mode. The first EEV 23 outputs a cold refrigerant, which is directed to a front heat exchanger 24 that is part of an engine cooling fan package 80. The engine cooling fan package 80 includes the front heat exchanger 24, a drive heat exchanger 64 (i.e., a radiator that is part of the drivetrain coolant loop 60) and an engine cooling fan 11 in a stacked arrangement that is typically located immediately behind the front grille (not shown) of a vehicle. The front heat exchanger 24 may transfer heat to the refrigerant, and thus outputs cool refrigerant to the compressor 21 via a shut-off valve (SOV) 25 and an accumulator 26. The compressor 21, the LCC 22, the first EEV 23, the front heat exchanger 24 and the accumulator 26 constitute a main refrigerant loop 8.

The refrigerant subsystem 20 can be controlled to redirect at least some refrigerant to other vehicle components, depending on the configuration of the respective components and the SOV 25. To this end, the refrigerant subsystem 20 includes a first sub-loop 9 in which refrigerant from the front heat exchanger 24 is directed to a second electronic expansion valve 28 prior to passing through the refrigerant side of the battery heat exchanger 51, where it cools the coolant of the battery coolant loop 50 and is then directed to the accumulator 26 and compressor 21, thus returning to the main refrigerant loop 8. In addition, the refrigerant subsystem 20 includes a second sub-loop 10 in which refrigerant from the front heat exchanger 24 is directed to a solenoid thermostatic expansion valve (TXV) 27. Cooled refrigerant exiting from the TXV 27 is directed to an evaporator 29 associated with a cabin heat exchanger 41 of the cabin coolant loop 40. A blower may draw air over both the evaporator 29 and the cabin heat exchanger 41 and into the cabin, bringing hot air in the case of a hot cabin heat exchanger 41 or cool air in the case of a relatively cold evaporator 29. Refrigerant exiting the evaporator 29 is directed to the accumulator 26 and the compressor 21, thus returning to the main refrigerant loop. Depending on the configuration of the respective components, refrigerant may flow through the first sub-loop 9 and not the second sub-loop 10, refrigerant may flow through the second sub-loop 10 and not the first sub-loop 9, or refrigerant may flow through both the first and second sub-loops 9, 10.

The refrigerant used in the refrigerant subsystem 20 is a substance suitable for use in a heat cycle is capable of undergoing a phase change between gas and liquid to allow cooling. For example, in some embodiments, the refrigerant used in the refrigerant subsystem 20 is R1234YF.

The coolant subsystem 30 includes the vehicle drivetrain coolant loop 60, the battery coolant loop 50 and the cabin coolant loop 40 which are selectively combined via proportional valves 44, 54 as required by operating conditions.

The cabin coolant loop 40 includes a first pump 43 that drives coolant fluid through the coolant subsystem 30. Coolant exiting the first pump 43 enters the coolant side of the LCC 22. Heat may be transferred to the coolant within the LCC 22 so that the temperature of the coolant exiting the LCC 22 is greater than the temperature of the coolant exiting the first pump 43. The coolant exiting the LCC 22 is directed to a positive temperature coefficient heater (PTC) 42, where additional heat may be added to the coolant. Thus, the temperature of the coolant exiting the PTC 42 is greater than the temperature of the coolant exiting the LCC 22. The LCC 22 and PTC 42 are in series, which allows for both components to simultaneously contribute heat to the cabin coolant loop 40. The cabin coolant loop 40 includes the cabin heat exchanger 41 that cooperates with the refrigerant cooled evaporator 29 and a blower to effect climate control of the vehicle cabin. For example, due to the relatively high temperature of the coolant flowing through the cabin heat exchanger 41, the temperature within the vehicle cabin may be increased if desired by the vehicle occupants. As discussed previously, refrigerant exiting the evaporator 29 is directed to the accumulator 26 and the compressor 21, thus returning to the main refrigerant loop 8.

Coolant exiting the cabin heat exchanger 41 is directed to a port of a first fluid control valve. In the illustrated embodiment, the first fluid control valve is a four-port coolant proportional valve (CPV) 44, and the coolant exiting the cabin heat exchanger 41 is directed to the first port of the four-port CPV 44. The inlet of the first pump 43 is connected to the second port of the four-port CPV 44, and the third port of the four-port CPV 44 is connected to the battery coolant loop 50, and particularly to an inlet of coolant side of the battery heat exchanger 51.

The battery coolant loop 50 includes the battery heat exchanger 51. The refrigerant side of the battery heat exchanger 51 is part of the first sub-loop of the refrigerant subsystem 20. Coolant exiting the battery heat exchanger 51 is directed to the battery 52, where it is used to cool individual electrochemical cells of the battery 52. Coolant exiting the battery 52 is directed to a port of a second fluid control valve. In the illustrated embodiment, the second fluid control valve is a five-port coolant proportional valve (CPV) 54, and the coolant exiting the battery 52 is directed to the first port of the five-port CPV 54. The battery coolant loop 50 includes a second pump 53, which is connected to a second port of the five-port CPV 54. The second pump 53 drives coolant fluid through the coolant subsystem 30 and is connected to an inlet of the first pump 43. The second pump 53 is also connected to the outlet of the third port of the four-port CPV 44 via a bypass line 56.

The vehicle drivetrain coolant loop 60 includes a third pump 63 that is fed from a reservoir 65. The inlet of the third pump 63 is connected to the fifth port of the five-port CPV 54. The outlet of the third pump 63 is connected to the vehicle power electronics 62, which may include, but is not limited to, a DC-DC converter and an on-board charger (OBC). Coolant exiting the power electronics 62 is directed to an e-axle 61. The e-axle 61 is a compact modular unit that includes the electric traction motor, electronics and the transmission that power the vehicle's axle. Depending on system requirements, the coolant exiting the e-axle 61 may be returned to the fourth port of the 5-port CPV 54 via the drive heat exchanger 64 of the engine cooling fan package 80, or alternatively may be returned to the third port of the 5-port CPV 54 while bypassing the drive heat exchanger 64.

The coolant used in the coolant subsystem 30 is a substance suitable for use in a vehicle cooling system. For example, in some embodiments, the coolant is a mixture of water and ethylene glycol.

The components of the coolant subsystem 30 are interconnected via the primary fluid passageways 1 that are used to define the loops 40, 50, 60 of the coolant subsystem 30. In addition, portions of the primary fluid passageway 1 may be defined by an internal surface of a housing of one or more components of the coolant subsystem 30.

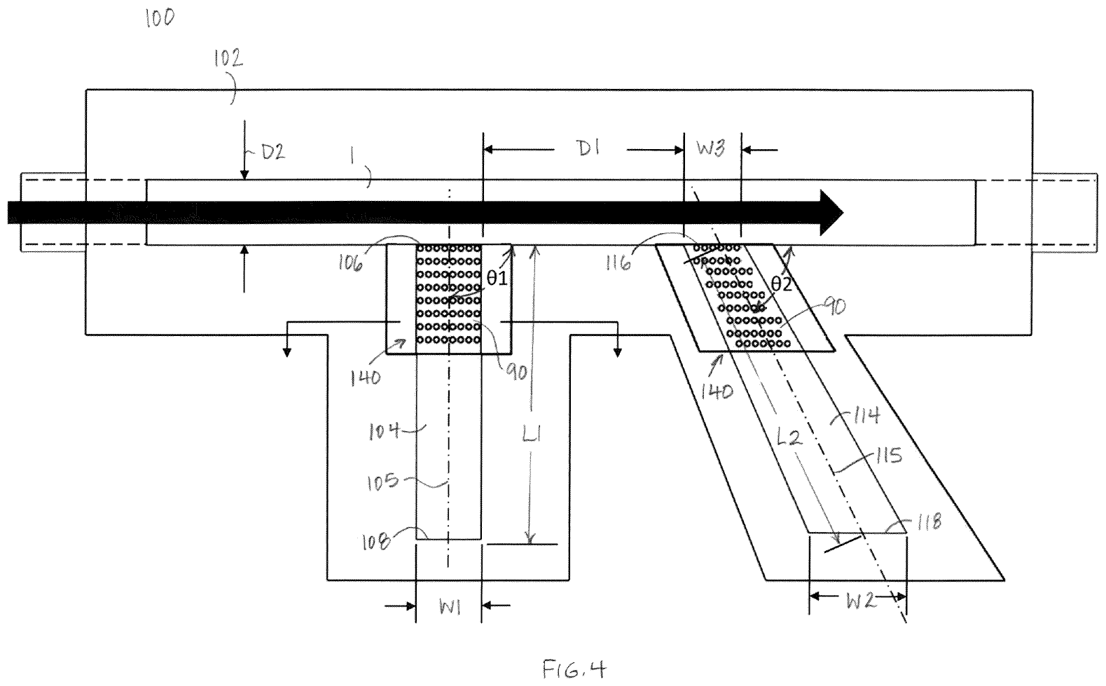

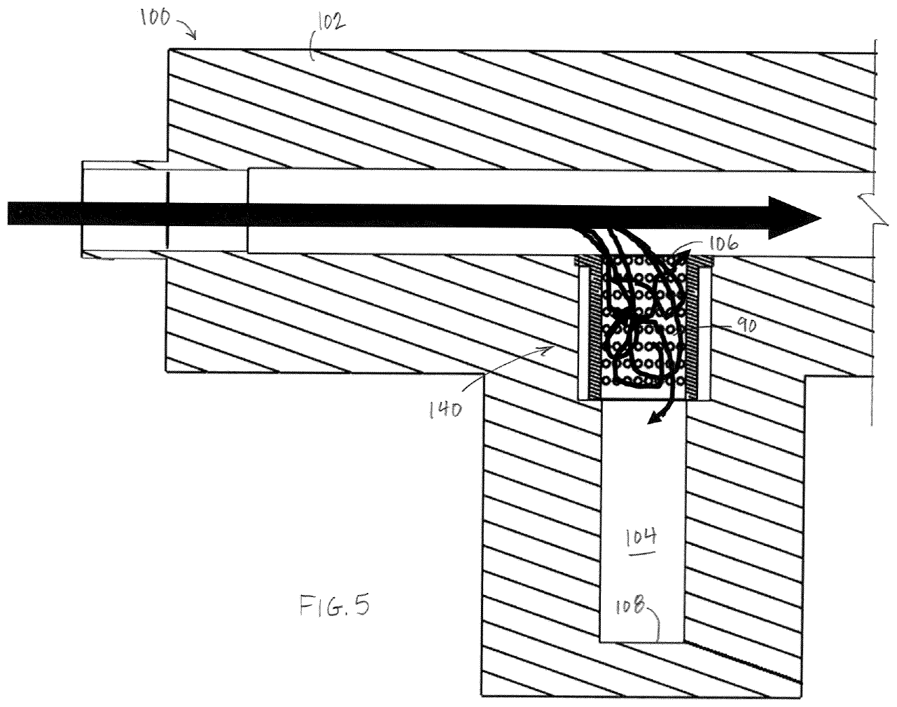

Referring to FIGS. 4-8, the settlement filter 100 is provided in the primary fluid passageway 1. The settlement filter 100 may be disposed within a housing of a component of the coolant subsystem 30 or may be disposed at a location between components. The settlement filter 100 is configured to take advantage of settling characteristics of particles suspended in the fluid to remove particle contaminants from the fluid. To this end, the settlement filter 100 includes at least one secondary fluid passageway (e.g., hereafter referred to as a filter fluid passageway) that intersects the primary fluid passageway 1. In addition, the settlement filter 100 includes a filter housing 102 that receives therethrough the fluid flowing through the primary fluid passageway 1. When the settlement filter 100 is disposed within a housing of a component of the coolant subsystem 30, the filter housing 102 may be integral with the component housing. When the settlement filter 100 is disposed between components of the coolant subsystem 30, the filter housing 102 may be provided in-line with the primary fluid passageway 1.

In the embodiment of FIGS. 4-6, the settlement filter 100 includes two filter fluid passageways 104, 114 that are formed in the filter housing 102 and intersect the primary fluid passageway 1. The first filter fluid passageway 104 includes a first inlet end 106 at the intersection with the primary fluid passageway 1 and extends linearly along a first line 105. The first filter fluid passageway 104 terminates in a first blind end 108 disposed at a location that is spaced apart from the first inlet end 106. The first blind end 108 may be planar and is generally perpendicular to the first line 105. The first filter fluid passageway 104 (e.g., the first line 105) intersects one side of the primary fluid passageway 1 at an angle θ1 of 90 degrees.

The first filter fluid passageway 104 has a first passageway length L1 corresponding to a distance between the first inlet end 106 and the first blind end 108, and a first passageway width W1 corresponding to a dimension of the first filter fluid passageway 104 in a direction perpendicular to the first passageway length L1 and perpendicular to the direction of the force of gravity. The width W1 of the first filter fluid passageway 104 is uniform from the first inlet end 106 to the first blind end 108. In addition, the first passageway length L1 is at least 1.5 times the first passageway width W1. In some embodiments, the first passageway length L1 is at least 10 times the first passageway width W1.

The first filter fluid passageway 104 fluidly communicates with the primary fluid passageway 1 and receives a portion of the fluid from the primary fluid passageway 1 due to turbulence at the first inlet end 106 and interaction between primary and secondary flows in this region.

The second filter fluid passageway 114 is located downstream of the first filter fluid passageway 104 with respect to a direction of fluid flow through the primary fluid passageway 1. The second filter fluid passageway 114 includes a second inlet end 116 at the intersection with the primary fluid passageway 1. The second inlet end 116 is located on the same side of the primary fluid passageway 1 as the first filter fluid passageway 104. The second filter fluid passageway 114 extends linearly along a second line 115 and terminates in a second blind end 118 disposed at a location that is spaced apart from the second inlet end 116. The second blind end 118 may be planar and is generally perpendicular to the second line 115.

The second filter fluid passageway 114 has a second passageway length L2 corresponding to a distance between the second inlet end 116 and the second blind end 118 as measured along the second line 115, and a second passageway width W2 corresponding to a dimension of the second filter fluid passageway 114 in a direction perpendicular to the second passageway length L2 and perpendicular to the direction of the force of gravity. The width of the second filter fluid passageway 114 is nonuniform from the second inlet end 116 to the second blind end 118. For example, in the illustrated embodiment, the width increases linearly from the second inlet end 116 to the second blind end 118. In some embodiments, the width W2 of the second blind end 118 may be twice or more the width W3 of the second inlet end 116. In addition, the second passageway length L2 is at least 1.5 times the mean second passageway width Wm=((W2+W3)/2). In some embodiments, the second passageway length L2 is at least 10 times the mean second passageway width Wm.

The second filter fluid passageway 114 (e.g., the second line 115) intersects the primary fluid passageway 1 at a second angle θ2 that is different from the first angle θ1. In the illustrated embodiment, the second angle θ2 is between 0 degrees and 90 degrees. For example, the second angle may be 35 degrees.

The second filter fluid passageway 114 fluidly communicates with the primary fluid passageway 1 and receives a portion of the fluid from the primary fluid passageway 1 due to turbulence at the second inlet end 116 and interaction between primary and secondary flows in this region.

In some embodiments, the spacing between the first and second filter passageways 104, 114 is set to be sufficiently long to ensure that a partially laminar flow is reestablished downstream of the first filter fluid passageway 104. For example, the distance D1 between the first inlet end 106 and the second inlet end 116 is in a range of 1.5 times the dimension D2 of the primary passageway 1 or more, where the dimension D2 of the primary fluid passageway 1 is measured at a location mid-way between the first inlet end 106 and the second inlet end 116 in a direction perpendicular to the direction of fluid flow through the primary fluid passageway 1.

In addition, the settlement filter 100 includes a particle trap 140. The particle trap 140 is defined by the filter housing 102 and a particle trap 140 is associated with each of the first and second filter fluid passageways 104, 114. The particle trap 140 is disposed in the settlement areas 90 of the filter fluid passageway 104, 114. In the illustrated embodiment, the settlement areas 90 are located in the floor 110 of the filter housing 102 at the respective inlet ends 106, 116. As used herein, the term “floor” refers to the lowermost surface of the passageway 1, 104, 114 with respect to the direction of the force of gravity.

The particle traps 140 are configured receive and retain particles that settle within the first and second filter fluid passageways 104, 114. Each particle trap 140 includes trap openings 142 and a particle trap receptacle 144 that underlies the trap openings 142. The trap openings 142 receive the particles that settle under force of gravity to the floor 110 within settlement area 90 due to the relatively low or zero fluid flow velocity within the settlement area 90. The particle trap 140 retains the particles that pass through the trap openings 142.

The trap openings 142 are through-openings provided in the floor 110 and are configured to allow passage of particles therethrough under force of gravity. In particular, the floor 110 of each of the first and second filter fluid passageways 104, 114 defines the trap openings 142, and each trap opening 142 is configured to allow passage of particles therethrough under force of gravity. Although the trap openings 142 are illustrated herein as having a circular shape, the trap openings 142 are not limited to this shape. Although the trap openings 142 are illustrated herein as having a uniform size, the trap openings 142 are not limited to having a uniform size. In some embodiments, the trap openings 142 may be formed in the floor 110 for example by drilling or etching. In other embodiments, the trap openings 142 may be provided by replacing the floor 110 within the settlement area 90 with a mesh screen.

The particle trap receptacle 144 underlies the floor 110 of each of the first and second filter fluid passageways 104, 114 in the vicinity of the trap openings 142. In the illustrated embodiment, the particle trap receptacle 144 underlies only the portion of the floor 110 corresponding to the settlement area 90 but the settlement filter 100 is not limited to this configuration. The trap openings 142 provide fluid communication between the respective first and second filter fluid passageway 104, 114 and an interior space 146 of the particle trap receptacle 144. When a suspended particle within the settlement area 90 drops from the fluid and settles under force of gravity on the floor 110, it may pass through one of the respective trap openings 142 and into the receptacle interior space 146. Since the receptacle interior space 146 is out of the path of fluid flow, the settlement filter 110 provides an enclosure that receives and retains the particles that pass through the trap openings 142.

The settlement filter 100 is configured to receive a portion of fluid (e.g., coolant) that passes through the primary fluid passageway 1 of the coolant subsystem 30 and to take advantage of settling characteristics of particles suspended in the fluid to remove particle contaminants from the fluid. When the settlement filter 100 is located in a portion of the fluid-flow system that is substantially horizontal, gravitational forces can drive the settled particles into the particle trap 140 and retain the particles therein. However, the settlement filter 100 is not limited to being located in a portion of the fluid-flow system that is substantially horizontal and will function when settlement filter 100 is placed at locations where the primary fluid passageway 1 is at an angle relative to the horizontal.

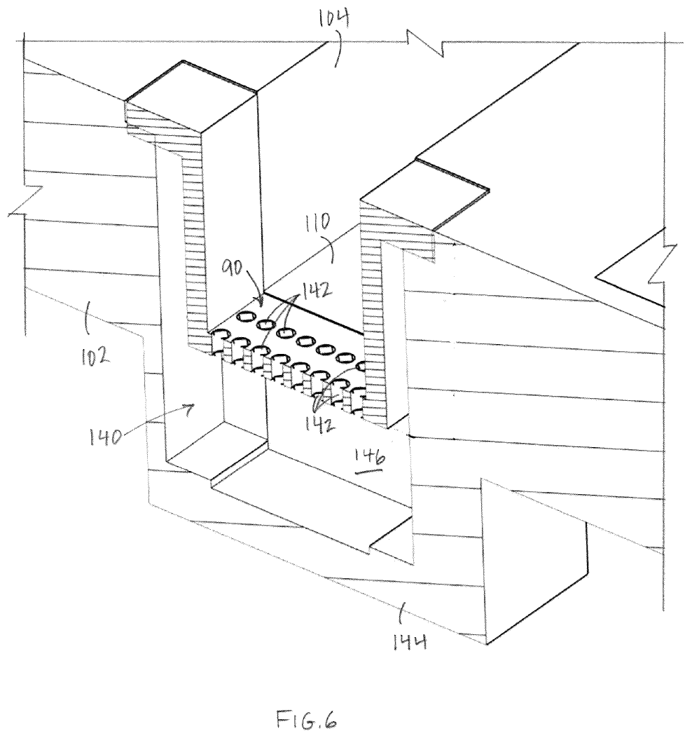

Referring to FIG. 7, although the settlement filter 100 is shown in FIGS. 4-6 as including the first and second filter fluid passageways 104, 114 arranged to be substantially coplanar with respect to the primary fluid passageway 1, the filter 100 is not limited to this configuration. For example, one or both of the first and second filter fluid passageways 104, 114 may be non-coplanar with respect to the primary fluid passageway 1. As seen in FIG. 7, which illustrates the primary fluid passageway 1 in end view and extending within a substantially horizontal plane, each of the first filter fluid passageway 104 and the second filter fluid passageway 114 extend at an angle relative to the plane P that includes the primary fluid passageway 1. In particular, the first filter fluid passageway 104 extends from the primary fluid passageway 1 at a third angle θ3 that is inclined relative to the plane P. In the illustrated embodiment the third angle θ3 may be as much as 35 degrees but is not limited to this angle. The second filter fluid passageway 114 extends from the primary fluid passageway 1 at a fourth angle θ4 that is declined relative to the plane P. In the illustrated embodiment the fourth angle θ4 may be as much as 135 degrees but is not limited to this angle. When inclined the efficiency of the settlement filter 100 may be lower than compared to a horizontal or substantially horizontal orientation.

Although the settlement filter 100 has been described herein as being used in a cooling system of an electric vehicle, the settlement filter 100 may be used in any cooling system and is not limited to being used in any type of vehicle. In particular, the filter may be used in the cooling system of an electric vehicle, a hybrid vehicle or a vehicle powered by an internal combustion engine.

The settlement filter 100 is not limited to being used in the cooling system of a vehicle and can be used in other applications such as the cooling systems of buildings or devices. Moreover, the settlement filter 100 is not limited to being used in a cooling system and may be employed in any fluid system.

The primary fluid passageway 1 and the first and second filter fluid passageways 104, 114 are illustrated herein as having a rectangular cross-sectional shape. However, the primary fluid passageway 1 and the first and second filter fluid passageways 104, 114 are not limited to a rectangular shape. For example, in some embodiments, the primary fluid passageway 1 and the first and second filter fluid passageways 104, 114 may have other closed, curved shapes such as circular, elliptical, rounded rectangular or squared circle.

Although the settlement filter 100 is illustrated herein as having a first filter fluid passageway 104 of uniform width and a second filter fluid passageway 114 of non-uniform width, the settlement filter 100 is not limited to this configuration. For example, in some embodiments, both the first and second filter fluid passageways 104, 114 have a uniform width. In other embodiments, both the first and second filter fluid passageways 104, 114 have a non-uniform width.

Referring to FIG. 8, the settlement filter 100 is not limited to the configuration illustrated in FIGS. 4-6. For example, an alternative embodiment settlement filter 200 includes the filter housing 102 and first filter fluid passageway 104 as described above with respect to FIGS. 4-6. The settlement filter 200 includes a second filter fluid passageway 214 that intersects the primary fluid passageway 1 on the same side of the primary fluid passageway 1 as the first filter fluid passageway 104. In addition, the second filter fluid passageway 214 is at an acute angle, e.g., an angle θ2 that is between 0 degrees and 90 degrees, for example 35 degrees.

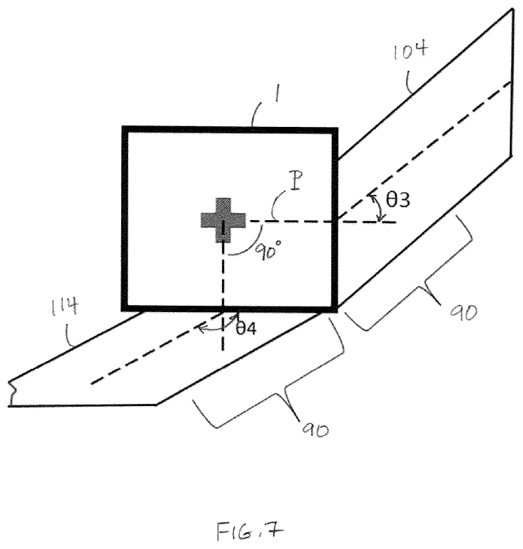

Referring to FIG. 9, another alternative embodiment settlement filter 300 includes the filter housing 102 and first filter fluid passageway 104 as described above with respect to FIGS. 4-6. The settlement filter 300 includes a second filter fluid passageway 314 that intersects the primary fluid passageway 1 on the same side of the primary fluid passageway 1 as the first filter fluid passageway 104. In addition, the second filter fluid passageway 314 is at right angle, e.g., an angle θ2 that is 90 degrees.

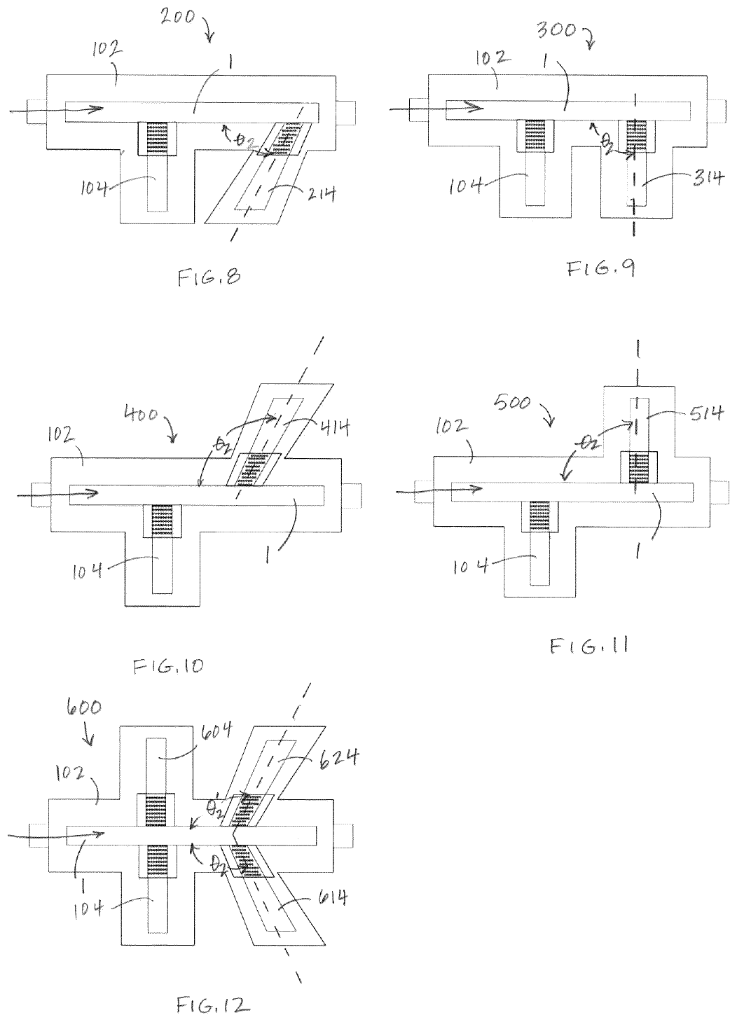

Referring to FIGS. 10 and 11, another alternative embodiment settlement filter 400 includes the filter housing 102 and first filter fluid passageway 104 as described above with respect to FIGS. 4-6. The settlement filter 400 includes a second filter fluid passageway 414 that intersects the primary fluid passageway 1 on the opposite side of the primary fluid passageway 1 relative to the first filter fluid passageway 104. The second filter fluid passageway 414 may intersect the primary fluid passageway 1 at an angle θ2 that is between 0 degrees and 90 degrees, at an angle θ2 that is 90 degrees (FIG. 11), or at an angle θ2 that is between 90 degrees and 180 degrees, for example 135 degrees (FIG. 10).

Referring to FIG. 12, although the settlement filter 100, 200, 300, 400, 500 is illustrated herein as having two filter fluid passageways 104, 114, the settlement filter 100, 200, 300, 400, 500 is not limited to this configuration. In some embodiments, the settlement filter 100, 200, 300, 400, 500 may have a single filter fluid passageway, whereas in other embodiments, the settlement filter 100, 200, 300, 400, 500 may have more than two filter fluid passageways. For example, another alternative embodiment filter 600 includes four filter fluid passageways 104, 604, 614 and 624. Although two pairs of opposed passageways (e.g., 104, 604 and 614, 624) are shown, each filter fluid passageway may be offset along the direction of fluid flow through the primary fluid passageway 1 with respect to the other filter fluid passageways. Moreover, the number, location and side of filter fluid passageways may be determined by, at least in part, the packaging requirements of the specific application. For example, all four filter fluid passageways may be on the same side of the primary fluid passageway 1 if needed due to space considerations.

Selective illustrative embodiments of the cooling system including the fluid filter are described above in some detail. Only structures considered necessary for clarifying the cooling system and the fluid filter have been described herein. Other conventional structures, and those of ancillary and auxiliary components of the cooling system and the fluid filter are assumed to be known and understood by those skilled in the art. Moreover, while a working example of the cooling system and the fluid filter have been described above, the cooling system and the fluid filter are not limited to the working example described above, but various design alterations may be carried out without departing from the cooling system and the fluid filter as set forth in the claims.

What is claimed is:

1. A fluid delivery system comprising:
a primary fluid passageway that extends between component of the fluid delivery system; and
a filter,
wherein the filter includes
a filter housing that defines a first filter fluid passageway that intersects the primary fluid passageway and is configured to receive a first portion of fluid that passes through the primary fluid passageway, the first filter fluid passageway having
a first inlet end that intersects and fluidly communicates with the primary fluid passageway, and
a first blind end disposed at a location that is spaced apart from the first inlet end.

2. The fluid delivery system of claim 1, wherein
the first filter fluid passageway has a surface that defines trap openings, and
each trap opening is configured to allow passage of particles therethrough under force of gravity.

3. The fluid delivery system of claim 1, wherein
the first filter fluid passageway defines a floor corresponding to the lowermost portion of the first filter fluid passageway with respect to the direction of the force of gravity of the earth, and
the floor has trap openings configured to allow passage of particles therethrough under force of gravity.

4. The fluid delivery system of claim 3, wherein
the filter housing comprises a vacancy that underlies the trap openings, the vacancy configured to receive and retain particles that pass through the trap openings.

5. The fluid delivery system of claim 1, wherein the first filter fluid passageway has a uniform width from the first inlet end to the first blind end.

6. The fluid delivery system of claim 1, wherein the first filter fluid passageway has a non-uniform width from the first inlet end to the first blind end.

7. The fluid delivery system of claim 1, wherein a width of the first filter fluid passageway increases from the first inlet end to the first blind end.

8. The fluid delivery system of claim 1, wherein the first filter fluid passageway is perpendicular to the primary fluid passageway.

9. The fluid delivery system of claim 1, wherein the first filter fluid passageway is at a non-right angle to the primary fluid passageway.

10. The fluid delivery system of claim 1, wherein the first filter fluid passageway has a first passageway length corresponding to a distance between the first inlet end and the first blind end and a first passageway width corresponding to a dimension of the first filter fluid passageway in a direction perpendicular to the first passageway length and to a direction of the force of gravity, and the first passageway length is at least 1.5 times the first passageway width.

11. The fluid delivery system of claim 1, wherein
the filter housing defines a second filter fluid passageway that intersects the primary fluid passageway and is configured to receive a first portion of fluid that passes through the primary fluid passageway, and
the second filter fluid passageway includes
a second inlet end that intersects and fluidly communicates with the primary fluid passageway, and
a second blind end disposed at a location spaced apart from the second inlet end.

12. The fluid delivery system of claim 11, wherein
each of the first filter fluid passageway and the second filter fluid passageway has a surface that defines trap openings, and
each trap opening is configured to allow passage of particles therethrough under force of gravity.

13. The fluid delivery system of claim 11, wherein the second inlet end is downstream of the first inlet end with respect to a direction of fluid flow through the primary fluid passageway.

14. The fluid delivery system of claim 11, wherein
the primary fluid passageway has a primary passageway cross-sectional dimension at a location mid-way between the first inlet end and the second inlet end, and
a distance between the first inlet end and the second inlet end is at least 1.5 times the primary passageway cross-sectional dimension.

15. The fluid delivery system of claim 11, wherein
the first filter fluid passageway has a uniform width from the first inlet end to the first blind end, and
the second filter fluid passageway has a non-uniform width from the second inlet end to the second blind end.

16. The fluid delivery system of claim 15, wherein the width of the second filter fluid passageway increases from the second inlet end to the second blind end.

17. The fluid delivery system of claim 11, wherein
the first filter fluid passageway intersects the primary fluid passageway at a first side of the primary fluid passageway, and
the second filter fluid passageway intersects the primary fluid passageway at the first side of the primary fluid passageway at a location downstream from the first filter fluid passageway with respect to the direction of fluid flow through the primary fluid passageway.

18. The fluid delivery system of claim 17, wherein
the first filter fluid passageway intersects the primary fluid passageway at a first side of the primary fluid passageway,
the second filter fluid passageway intersects the primary fluid passageway at a second side of the primary fluid passageway at a location downstream from the first filter fluid passageway with respect to the direction of fluid flow through the primary fluid passageway, and
the second side is opposite the first side.

19. The fluid delivery system of claim 1, wherein
one of the first filter fluid passageway and the second filter fluid passageway is at a right angle to the primary fluid passageway, and
the other of the first filter fluid passageway and the second filter fluid passageway is at a non-right angle to the primary fluid passageway.
